(19) United States
(12) Patent Application Publication
(10) Pub. No.: US 2004/0252483 A1
(43) Pub. Date: Dec. 16, 2004

(54) Backlight system and liquid crystal display using the same

(76) Inventor: Wen Feng Cheng, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/867,967

(22) Filed: Jun. 14, 2004

(30) Foreign Application Priority Data
Jun. 11, 2003 (TW) 92210679

(51) Int. Cl. F21V 7/04

(52) U.S. Cl. 362/31

(57) ABSTRACT

A backlight system (100) in accordance with the present invention includes a plurality of light sources (110) for emitting light beams and a light guide plate (120) for receiving the light beams emitted by the light sources. The light guide plate includes a light input surface (121) and a light output surface (122) joining the light input surface. The light input surface has a number of recessed portions (124) therein. The light beams are refracted and diffused by the recessed portions, and are then transmitted through the light guide plate to be emitted with a high degree of uniformity through the light output surface.

### BACKGROUND OF THE INVENTION

1. Field of the Invention

The present invention relates to a backlight device and particularly to an edge light type backlight device for use in a liquid crystal display (LCD) or the like.

2. The Related Arts

An LCD device comprises, for example, a liquid crystal display panel and a backlight system mounted under the liquid crystal display panel for supplying light beams thereto. The backlight system mainly comprises at least a light source for emitting light beams and a light guide plate for receiving the light beams from a light input surface and emitting the light beams from a light output surface to uniformly illuminate the liquid crystal display panel.

However, the light source used in a backlight system has a certain divergent angle. For example, light emitting diodes (LEDs) used as light sources emit light beams with a divergent angle in a range of 30° to 130°. FIG. 6 shows a light beam distribution of a backlight system using LEDs as light sources. This conventional backlight system comprises a light guide plate 3 and a plurality of LEDs (not shown) arranged at one side of the light guide plate 3 for providing light beams. In operation, light beams emitted by the LEDs enter into the light guide plate 3 through a corresponding light incident point 2, and then transmit out from a light output surface (not label) thereof. The light guide plate 3 yields a plurality of dark areas 32 between two adjacent light incident points 2 due to each light source having a certain divergent angle. Thus, it is difficult to obtain a uniform illumination for the backlight system.

Referring to FIG. 7, to solve the above problem, TW Pat. No. 530,919 provides a backlight system having less dark area therein. The backlight system includes a plurality of holes 10 defined through a light guide plate 30 thereof. The backlight system has a plurality of LEDs (not shown) for emitting light beams. The light guide plate 30 includes at least one hole 10 defined opposite to a corresponding light incident point 20. It is preferable that the holes 10 be arranged in a shape of an arc surrounding the corresponding light incident point 20. In operation, light beams emitted by the LEDs enter into the light guide plate 30 through the light incident points 20, and the incident light beams are refracted and total internally reflected to every region of the light guide plate 30 by the holes 10. After being refracted and reflected by the holes 10, these incident light beams continue to be reflected until they are emitted out from a light output surface of the light guide plate 30.

However, in the backlight system having the above described structure, the holes 10 are arranged adjacent to a light incident surface (not labeled) of the light guide plate 30, so some incident light beams should be reflected back to and then emitted from the light incident surface due to the total internal reflection occurring on a boundary between the holes 10 and the light guide plate 30. Thus, the amount of incident light that can continually travel in the light guide plate 30 is decreased, and use of the incident light beams could be improved. Furthermore, part of the incident energy of the incident light beams is lost due to refraction and reflection by the holes 10 when the light beams transmit in the light guide plate 30. In additional, the holes 10 divide the light guide plate 30 into two parts: a front region surrounded by the holes 10, and a rear region. The holes 10 block incident light from spreading from the front region to the rear region since the holes 10 and the light guide plate 30 having different refractive indexes. Thus, the uniformity of the light emitted from the light output surface of the light guide plate 30 is impaired.

It is desirable to provide an improved backlight system for use in a liquid crystal display device, which overcomes the above problems.

### SUMMARY OF THE INVENTION

An object of the present invention is to provide a backlight system with less dark area and with a better uniform light distribution performance.

A backlight system in accordance with the present invention comprises at least a light source for emitting light beams and a light guide plate for receiving the light beams emitted by the light source. The light guide plate comprises a light input surface and a light output surface joining to the light input surface. The light input surface comprises a plurality of recessed portions therein, and the light beams emitted by the light sources are transmitted through the light guide plate after being refracted and diffused by the recessed portions.

Other objects, advantages, and novel features of the present invention will become more apparent from the following detailed description when taken in conjunction with the accompanying drawings.

### BRIEF DESCRIPTION OF THE DRAWINGS

FIG. 1 is a perspective view of a backlight system according to the present invention;

FIG. 2 is a plan view of the backlight system in FIG. 1;

FIG. 3 is a partial, essential optical paths diagram of a recessed portion shown in FIG. 1;

FIG. 4 is a bottom view of a light guide plate shown in FIG. 1;

FIG. 5 is a schematic view of a liquid crystal display device employing the backlight system in FIG. 1;

FIG. 6 is a view of a conventional backlight system; and

FIG. 7 is a schematic, plan view of another conventional backlight system.

### DETAILED DESCRIPTION OF THE INVENTION

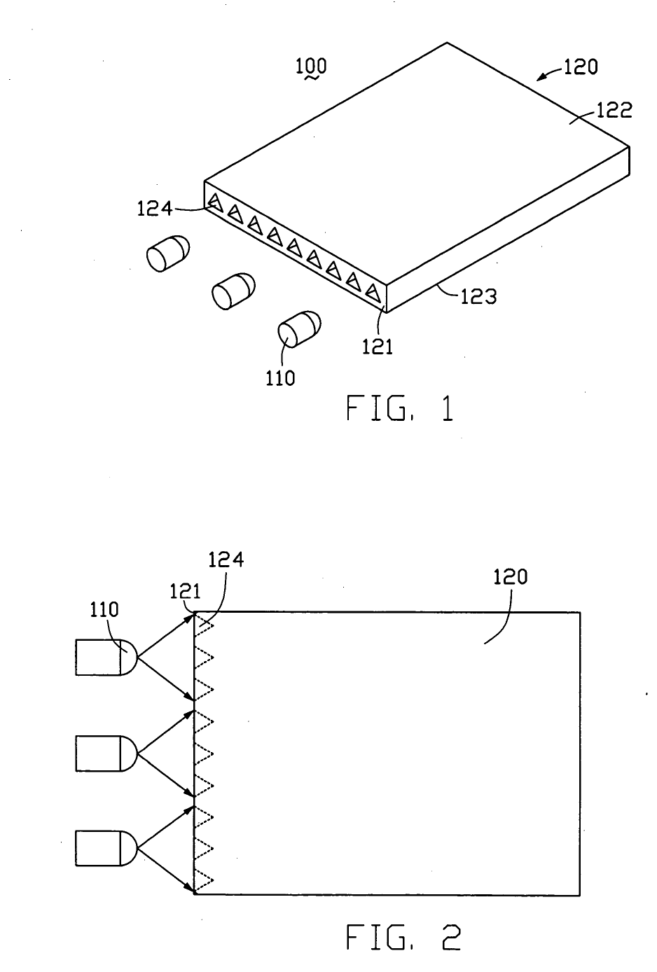

Referring to FIGS. 1 and 2, a backlight system 100 in accordance with the present invention is used to illuminate a liquid crystal display panel. The backlight system 100 comprises a plurality of light sources 110 and a light guide plate 120. The light sources 110 emit light beams, and the light guide plate 120 is arranged close to the light sources 110 to receive the light beams emitted by the light sources 110.

The light sources 110 can be light emitting diodes, miniature bulbs, or the like. Luminance of the light sources 110 can be adjusted.

The light guide plate 120 comprises a light input surface 121, a light output surface 122 joining to the light input surface 121, and a bottom surface 123 opposite to the light output surface 122. The light guide plate 120 can be a planar plate or a wedge-shape plate. The light input surface 121 comprises a plurality of recessed portions 124 therein. Each recessed portion 124 preferably has a shape of a polyhedron having a multi-sided surface. However, the recessed portions 124 may instead have a shape of an arced, an oval, or an elliptical depression or the like. The recessed portions 124 are arranged opposite to the light sources 110 to refract and diffuse the light beams emitted by the light sources 110. Because each light source 110 emits light beams within a certain divergent angle, it forms a corresponding light projective region (not labeled) on the light input surface 121 of the light guide plate 120. Each recessed portion 124 is preferably located in the light projective region formed by a corresponding light source 110. The recessed portions 124 may or may not be arranged at intervals in the corresponding light projective region and can be manufactured by molding or by a v-cut method. Each light input surface 121 further has an anti-reflective film (not shown) thereon, which covers the light input surfaces 121 and the recessed portions 124. The anti-reflective film improves effective utilization of the light beams emitted by the light sources 110 and increases the amount of light which enter into the light guide plate 120.

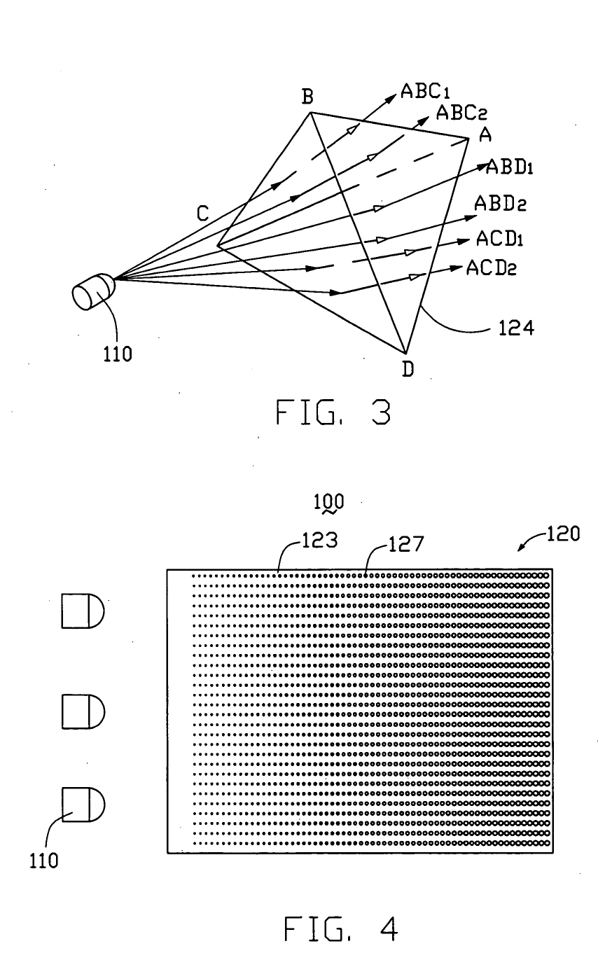

FIG. 3 shows a partial essential optical paths diagram of each recessed portion 124 as shown in FIG. 1. Each recessed portion 124 shown has a pyramided shape and includes light interfaces ABD, ABC and ACD, located at different orientations, respectively. Light beams ABD₁, ABD₂, ABC₁, ABC₂, ACD₁, and ACD₂ emitted by one of the light sources 110 are incident on the corresponding light interfaces ABD, ABC and ACD, respectively. After being refracted and diffused by the corresponding light interface ABD, ABC and ACD respectively, the light beams enter into the light guide plate 120 for use.

Referring to FIG. 4, the bottom surface 123 of the light guide plate 120 further comprises a dot-pattern 127 thereon, for improving the uniformity of light emitted from the light guide plate 120. The dot-pattern 127 can be manufactured by a screen-printing process or an injection molding process. A size of the dots in the dot-pattern 127 increases in a direction away from the light sources 110. A shape of each dot can be hemispherical, cylindrical, square, or cone-shaped. Moreover, a plurality of v-cut grooves (not show) can be formed in the bottom surface 123 to substitute for the dot-pattern 127. The bottom surface 123 further includes a reflective coating (not shown) thereon, which reflects the light beams to prevent the light beams from transmitting out of the light guide plate 120 through the bottom surface 123.

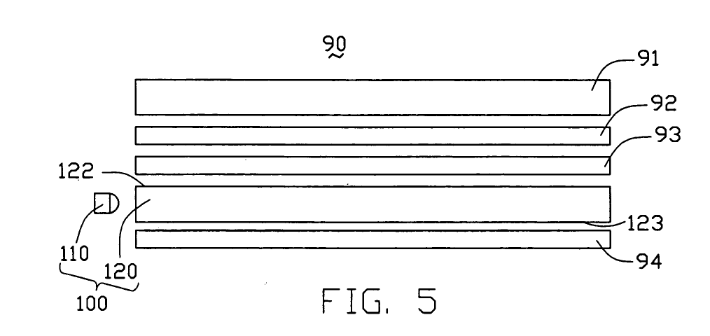

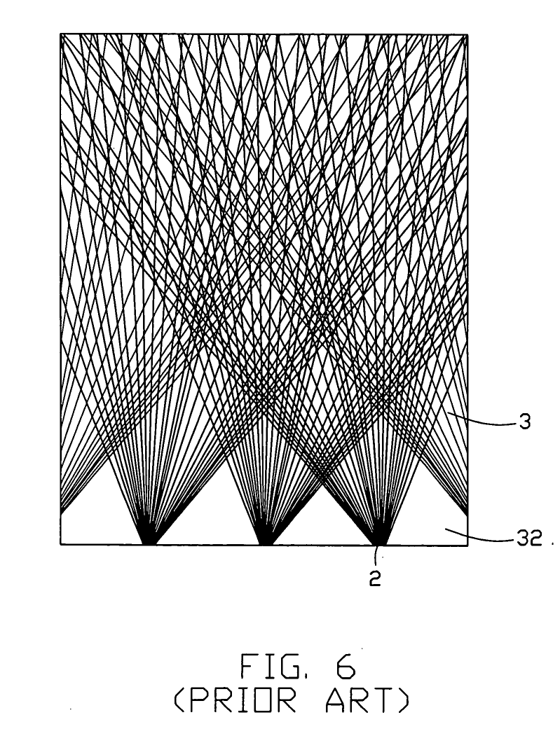

FIG. 5 shows an LCD device 90 employing the backlight system 100. The LCD device 90 comprises a reflection sheet 94, the backlight system 100 in FIG. 1, a diffusion sheet 93, a prism sheet 92 and a liquid crystal panel 91 which are arranged in order. In operation, light beams emitted by the light sources 110 enter the light guide plate 120, and are then transmitted out from the light output surface 122, and then pass through the diffusion sheet 93 and the prism sheet 92 to illuminate the liquid crystal panel 91. The reflection sheet 94 reflects light beams transmitting through the bottom surface 123 of the light guide plate 120 back into the light guide plate 120 for use again.

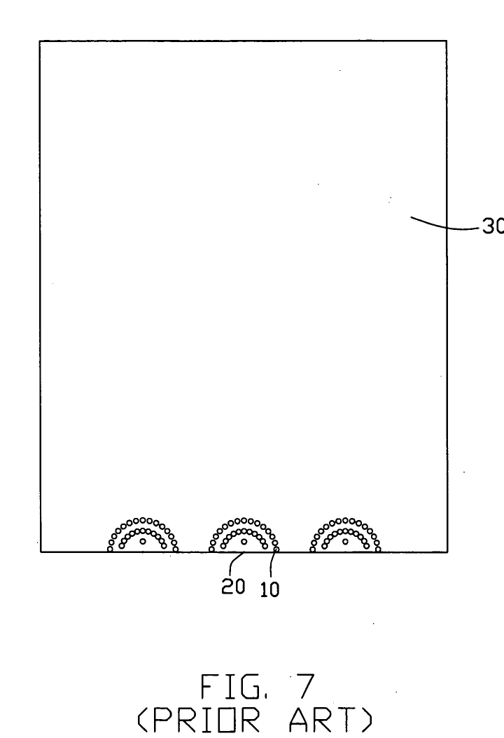

Advantages of the present invention over the prior art include the following. The recessed portions 124 can disperse the light beams emitted from the light sources 110 when they enter the light guide plate 120. Thus, an extent of the dark areas 32 (in FIG. 6) is minimized, while the uniformity of light beams emitted from the light guide plate 120 is increased. Furthermore, the recessed portions 124 are located in the light input surface 121 of the light guide plate 120, so that the incident light will not be blocked from traveling towards an inner region of the light guide plate 120 by intervening holes, as in the Prior Art of FIG. 7. Moreover, in the present invention, according to Snell's Law, the light beams are preventing from undergoing total internal reflection when they transmit across the light interfaces ABD, ABC, ACD, because they approach from a low density medium (the refractive index of air is 1) to a higher density medium (a refractive index of the light guide plate is approximately 1.49). Therefore, the light guide plate 120 provides better illumination and a more uniform light output.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight system for a display device comprising:
a light guide plate having a light incident surface; and
at least a light source installed in the vicinity of the light incident surface of the light guide plate for emitting light beams;
wherein the light incident surface has at least a recessed portion provided for refracting and scattering the light beams emitted from the light source.

2. The backlight system as described in claim 1, wherein the at least a recessed portion has a multi-sided surface.

3. The backlight system as described in claim 1, wherein the at least a recessed portion has a shape of a polyhedron.

4. The backlight system as described in claim 2, wherein the at least a recessed portion is located in a light projective region formed by a corresponding light source.

5. The backlight system as described in claim 3, wherein the at least a recessed portion is located in a light projective region formed by a corresponding light source.

6. A backlight system for a display device comprising:
at least a light source for emitting light beams; and
a light guide plate having a light incident surface and a light emitting surface orthogonal to the light incident surface, the light incident surface having a plurality of recessed portions defined therein, the recessed portions each having a multi-sided surface to refract and scatter the light beams emitted by the light source, the light beams then being transmitted through the light guide plate and emitting from the light emitting surface thereof.

7. The backlight system as described in claim 6, wherein the plurality of recessed portions are located in a corresponding light projective region formed by a corresponding light source.

8. The backlight system as claimed in claim 6, wherein the at least a light sources can be light emitting diode or miniature bulb.

9. The backlight system as claimed in claim 6, wherein the light guide plate can be a planar plate or a wedge plate.

10. The backlight system as claimed in claim 6, wherein the light incident surface has an anti-reflection coating thereon.

11. The backlight system as claimed in claim 6, wherein the light guide plate further comprises a bottom surface opposite to the light emitting surface.

12. The backlight system as claimed in claim 11, wherein the bottom surface has a dot-pattern thereon or has a plurality of v-cut grooves therein.

13. A liquid crystal display device comprising:
a liquid crystal panel; and
a backlight system arranged under the liquid crystal panel for illuminating it, the backlight system comprising:
light emitting diodes for emitting light beams; and
a light guide plate having a light input surface for receiving the light beams and a light output surface for emitting the light beams, the light input surface having a plurality of recessed portions defined therein, each recessed portion having a multi-sided surface to refract the light beams and transmit them in scattered direction.

14. The liquid crystal display device as claimed in claim 13, wherein the plurality of recessed portions are located in a corresponding light projective region formed by a corresponding light source.

15. The liquid crystal display device as claimed in claim 13, wherein the light guide plate can be a planar plate or a wedge plate.

16. The liquid crystal display device as claimed in claim 13, wherein the light input surface has an anti-reflection coating thereon.

17. The liquid crystal display device as claimed in claim 13, wherein the light guide plate further comprises a bottom surface opposite to the light output surface.

18. The liquid crystal display device as claimed in claim 17, wherein the bottom surface has a dot-pattern thereon or has a plurality of v-cut grooves therein.
